(19) United States
(12) Patent Application Publication
(10) Pub. No.: US 2026/0267383 A1
(43) Pub. Date: Sep. 10, 2026

(54) APPARATUS WITH AN ADJUSTABLE-POWER SENSE AMPLIFIER AND METHODS FOR OPERATING THE SAME

(71) Applicant: Micron Technology, Inc., Boise, ID (US)

(72) Inventors: Emilie Anna Camille Charlot de Courcy, Tokyo (JP); Yuko Watanabe, Tokyo (JP); Shinichi Miyatake, Kanagawa (JP)

(21) Appl. No.: 19/544,929

(22) Filed: Feb. 19, 2026

Related U.S. Application Data
(60) Provisional application No. 63/769,602, filed on Mar. 10, 2025.

(51) Int. Cl. G06F 1/26

(52) U.S. Cl. CPC G06F 1/26

(57) ABSTRACT

Methods, apparatuses, and systems related to a memory device are described. The memory device may include a sense amplifier that is configured to amplify stored charges of a memory cell using an intermediate read voltage supplied by a first power source, amplify stored charges of the memory cell using a target read voltage that is greater than the intermediate read voltage and supplied by a second power source, and read one or more data values represented by the amplified stored charges of the memory cell.

### CROSS-REFERENCE TO RELATED APPLICATIONS

The present application claims priority to U.S. Provisional Patent Application No. 63/769,602, filed Mar. 10, 2025, the disclosure of which is incorporated herein by reference in its entirety.

### TECHNICAL FIELD

The disclosed embodiments relate to devices, and, in particular, to semiconductor memory devices with an adjustable-power sense amplifier and methods for operating the same.

### BACKGROUND

An apparatus (e.g., a processor, a memory system, and/or other electronic apparatus) can include one or more semiconductor circuits configured to store and/or process information. For example, the apparatus can include a memory device, such as a volatile memory device, a non-volatile memory device, or a combination device. Memory devices, such as dynamic random-access memory (DRAM), can utilize electrical energy to store and access data.

### BRIEF DESCRIPTION OF THE DRAWINGS

FIG. 1 is a block diagram of an apparatus in accordance with an embodiment of the present technology.

FIG. 2 is a schematic block diagram of an example read circuit in accordance with an embodiment of the present technology.

FIG. 3A is a circuit diagram of an example sense amplifier in accordance with an embodiment of the present technology.

FIG. 3B is a circuit diagram of an example variable voltage source in accordance with an embodiment of the present technology.

FIG. 4A is a circuit diagram of the example sense amplifier of FIG. 3A in a first state in accordance with an embodiment of the present technology.

FIG. 4B is a timing diagram for the first state in accordance with an embodiment of the present technology.

FIG. 4C is a circuit diagram of the example sense amplifier of FIG. 3A in a second state in accordance with an embodiment of the present technology.

FIG. 4D is a timing diagram for the second state in accordance with an embodiment of the present technology.

FIG. 4E is a circuit diagram of the example sense amplifier of FIG. 3A in a third state in accordance with an embodiment of the present technology.

FIG. 4F is a timing diagram for the third state in accordance with an embodiment of the present technology.

FIG. 5 is a flow diagram illustrating an example method of operating an apparatus in accordance with an embodiment of the present technology.

FIG. 6 is a schematic view of a system that includes an apparatus in accordance with an embodiment of the present technology.

### DETAILED DESCRIPTION

As described in greater detail below, the technology disclosed herein relates to an apparatus, such as for memory systems, systems with memory devices, related methods, etc., that adjusts a supplied voltage to a sense amplifier during a read operation. The apparatus can include a sense amplifier with a variable voltage source. Based on the variable voltage source, the sense amplifier can be configured to use an intermediate restoration voltage level to (1) charge sensing nodes that are connected to digit lines at a reduced voltage level and (2) dampen signal amplification during a first portion of an operation for reading information from connected memory cells. The sense amplifier can switch the variable voltage source to a restoration voltage level during a second portion of the read operation.

Using the variable voltage source to vary the input voltage to the sense amplifier during the read operation provides improved margin gain (e.g., 30% or greater) and reduce sensitivity to sense timing variation. Moreover, the variable voltage source at the sense amplifier can provide increased tuning options; the additional voltage level(s) can correspond to an additional option to adjust the trim values.

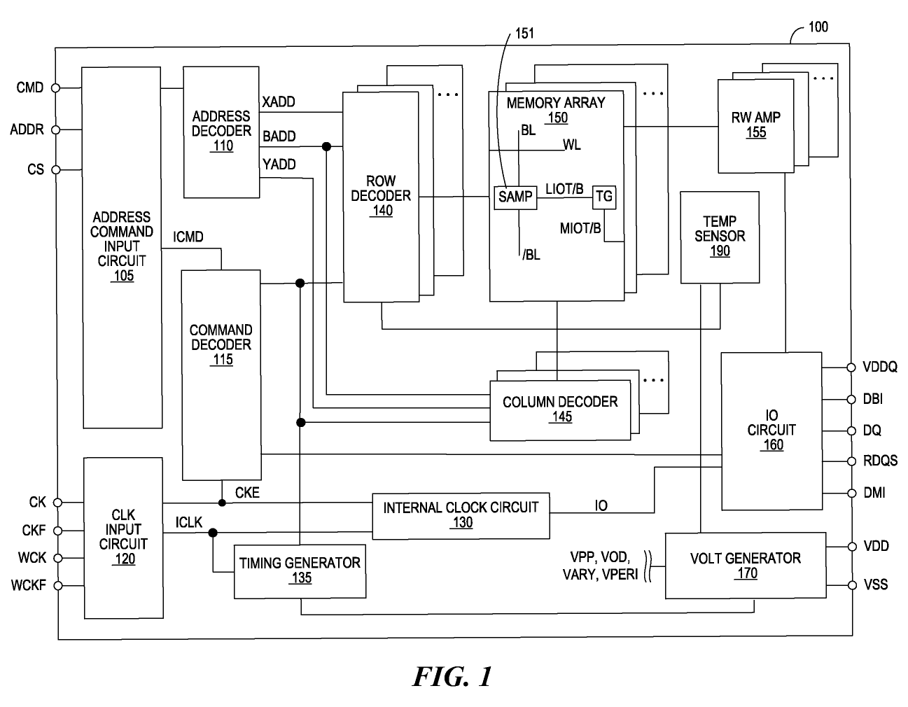

FIG. 1 is a block diagram of an apparatus 100 (e.g., a semiconductor die assembly, including a three-dimensional integration (3DI) device or a die-stacked package) in accordance with an embodiment of the present technology. For example, the apparatus 100 can include a DRAM or a portion thereof that includes one or more dies/chips.

The apparatus 100 may include an array of memory cells, such as memory array 150. The memory array 150 may include a plurality of banks (e.g., banks 0–15), and each bank may include a plurality of word-lines (WL), a plurality of bit lines (BL), and a plurality of memory cells arranged at intersections of the word-lines and the bit lines. Memory cells can include any one of a number of different memory media types, including capacitive, magnetoresistive, ferroelectric, phase change, or the like. The selection of a word-line WL may be performed by a row decoder 140, and the selection of a bit line BL may be performed by a column decoder 145.

Sense amplifiers (SAMP) 151 may be provided for corresponding bit lines BL and connected to at least one respective local I/O line pair (LIOT/B), which may in turn be coupled to at least respective one main I/O line pair (MIOT/B), via transfer gates (TG), which can function as switches. In some examples, the sense amplifiers 151 may include threshold voltage compensation circuitry that compensates for threshold voltage (Vt) differences between components of the sense amplifiers 151. The sense amplifiers 151 and transfer gates may be operated based on control signals from decoder circuitry, which may include the command decoder 115, the row decoders 140, the column decoders 145, any control circuitry of the memory array 150, or any combination thereof. The memory array 150 may also include plate lines and corresponding circuitry for managing their operation.

As circuit components become smaller, clock speeds become faster, and voltage/power consumption requirements are reduced. Small variances in the performance between circuit components of the sense amplifiers 151 (e.g., due to process, voltage, and temperature (PVT) variance) may reduce operational reliability of the apparatus 100. To mitigate effects of these variations, compensating for some of these threshold voltage differences may include, before activating the sense amplifier 151 to sense data, biasing digit lines (e.g., DL and DLb) coupled to the sense amplifiers 151 using internal nodes thereof that are configured to provide sensed data to an output (e.g., gut nodes). The bias of the digit lines may be based on threshold differences between at least two circuit components (e.g., transistors) of the sense amplifier 151. Compensating for threshold voltage Vt differences between circuit components within the sense amplifier 151 may improve reliability.

The apparatus 100 may employ a plurality of external terminals that include command and address terminals coupled to a command bus and an address bus to receive command signals (CMD) and address signals (ADDR), respectively. The apparatus 100 may further include a chip select terminal to receive a chip select signal (CS), clock terminals to receive clock signals CK and CKF, data clock terminals to receive data clock signals WCK and WCKF, data terminals DQ, RDQS, DBI, and DMI, power supply terminals VDD, VSS, and VDDQ.

The command terminals and address terminals may be supplied with an address signal and a bank address signal (not shown in FIG. 1) from outside. The address signal and the bank address signal supplied to the address terminals can be transferred, via a command/address input circuit 105, to an address decoder 110. The address decoder 110 can receive the address signals and supply a decoded row address signal (XADD) to the row decoder 140, and a decoded column address signal (YADD) to the column decoder 145. The address decoder 110 can also receive the bank address signal and supply the bank address signal to both the row decoder 140 and the column decoder 145.

The command and address terminals may be supplied with command signals (CMD), address signals (ADDR), and chip select signals (CS), from a memory controller and/or a nefarious chipset. The command signals may represent various memory commands from the memory controller (e.g., including access commands, which can include read commands and write commands). The chip select signal may be used to select the apparatus 100 to respond to commands and addresses provided to the command and address terminals. When an active chip select signal is provided to the apparatus 100, the commands and addresses can be decoded, and memory operations can be performed. The command signals may be provided as internal command signals ICMD to a command decoder 115 via the command/address input circuit 105. The command decoder 115 may include circuits to decode the internal command signals ICMD to generate various internal signals and commands for performing memory operations, for example, a row command signal to select a word-line and a column command signal to select a bit line. The command decoder 115 may further include one or more registers for tracking various counts or values (e.g., counts of refresh commands received by the apparatus 100 or self-refresh operations performed by the apparatus 100).

Read data can be read from memory cells in the memory array 150 designated by row address (e.g., address provided with an active command) and column address (e.g., address provided with the read). The read command may be received by the command decoder 115, which can provide internal commands to input/output circuit 160 so that read data can be output from the data terminals DQ, RDQS, DBI, and DMI via read/write amplifiers 155 and the input/output circuit 160 according to the RDQS clock signals. The read data may be provided at a time defined by read latency information RL that can be programmed in the apparatus 100, for example, in a mode register (not shown in FIG. 1). The read latency information RL can be defined in terms of clock cycles of the CK clock signal. For example, the read latency information RL can be a number of clock cycles of the CK signal after the read command is received by the apparatus 100 when the associated read data is provided.

Write data can be supplied to the data terminals DQ, DBI, and DMI according to the WCK and WCKF clock signals. The write command may be received by the command decoder 115, which can provide internal commands to the input/output circuit 160 so that the write data can be received by data receivers in the input/output circuit 160 and supplied via the input/output circuit 160 and the read/write amplifiers 155 to the memory array 150. The write data may be written in the memory cell designated by the row address and the column address. The write data may be provided to the data terminals at a time that is defined by write latency WL information. The write latency WL information can be programmed in the apparatus 100, for example, in the mode register. The write latency WL information can be defined in terms of clock cycles of the CK clock signal. For example, the write latency information WL can be a number of clock cycles of the CK signal after the write command is received by the apparatus 100 when the associated write data is received.

The power supply terminals may be supplied with power supply potentials V_{DD} and V_{SS}. These power supply potentials V_{DD} and V_{SS} can be supplied to an internal voltage generator circuit 170. The internal voltage generator circuit 170 can generate various internal potentials V_{PP}, V_{OD}, V_{ARY}, V_{PERI}, and the like based on the power supply potentials V_{DD} and V_{SS}. The internal potential V_{PP} can be used in the row decoder 140, the internal potentials V_{OD} and V_{ARY} can be used in the sense amplifiers included in the memory array 150, and the internal potential V_{PERI} can be used in many other circuit blocks.

The power supply terminal may also be supplied with power supply potential V_{DDQ}. The power supply potential V_{DDQ} can be supplied to the input/output circuit 160 together with the power supply potential VSS. The power supply potential V_{DDQ} can be the same potential as the power supply potential V_{SS} in an embodiment of the present technology. The power supply potential V_{DDQ} can be a different potential from the power supply potential V_{DD} in another embodiment of the present technology. However, the dedicated power supply potential V_{DDQ} can be used for the input/output circuit 160 so that power supply noise generated by the input/output circuit 160 does not propagate to the other circuit blocks.

The clock terminals and data clock terminals may be supplied with external clock signals and complementary external clock signals. The external clock signals CK, CKF, WCK, WCKF can be supplied to a clock input circuit 120. The CK and CKF signals can be complementary, and the WCK and WCKF signals can also be complementary. Complementary clock signals can have opposite clock levels and transition between the opposite clock levels at the same time. For example, when a clock signal is at a low clock level a complementary clock signal is at a high level, and when the clock signal is at a high clock level the complementary clock signal is at a low clock level. Moreover, when the clock signal transitions from the low clock level to the high clock level the complementary clock signal transitions from the high clock level to the low clock level, and when the clock signal transitions from the high clock level to the low clock level the complementary clock signal transitions from the low clock level to the high clock level.

Input buffers included in the clock input circuit 120 can receive the external clock signals. For example, when enabled by a clock/enable signal from the command decoder 115, an input buffer can receive the clock/enable signals. The clock input circuit 120 can receive the external clock signals to generate internal clock signals ICLK. The internal clock signals ICLK can be supplied to an internal clock circuit 130. The internal clock circuit 130 can provide various phase and frequency controlled internal clock signals based on the received internal clock signals ICLK and a clock enable (not shown in FIG. 1) from the command/address input circuit 105. For example, the internal clock circuit 130 can include a clock path (not shown in FIG. 1) that receives the internal clock signal ICLK and provides various clock signals to the command decoder 115. The internal clock circuit 130 can further provide input/output (IO) clock signals. The IO clock signals can be supplied to the input/output circuit 160 and can be used as timing signals for determining output timing of read data and/or input timing of write data. The IO clock signals can be provided at multiple clock frequencies so that data can be output from and input to the apparatus 100 at different data rates. A higher clock frequency may be desirable when high memory speed is desired. A lower clock frequency may be desirable when lower power consumption is desired. The internal clock signals ICLK can also be supplied to a timing generator 135 and thus various internal clock signals can be generated.

The apparatus 100 can be connected to any one of a number of electronic devices capable of utilizing memory for the temporary or persistent storage of information, or a component thereof. For example, a host device of apparatus 100 may be a computing device such as a desktop or portable computer, a server, a hand-held device (e.g., a mobile phone, a tablet, a digital reader, a digital media player), or some component thereof (e.g., a central processing unit, a co-processor, a dedicated memory controller, etc.). The host device may be a networking device (e.g., a switch, a router, etc.) or a recorder of digital images, audio and/or video, a vehicle, an appliance, a toy, or any one of a number of other products. In one embodiment, the host device may be connected directly to apparatus 100; although in other embodiments, the host device may be indirectly connected to memory device (e.g., over a networked connection or through intermediary devices).

The apparatus 100 may include a temperature sensing circuit (e.g., or alternatively “temperature sensor 190”) configured to measure the operating temperature of the apparatus 100, or components thereof. In some embodiments, the temperature sensor 190can be configured to determine separate operational temperature readings for each circuit block. The temperature sensor 190 may be coupled to the row decoder of the memory array 150, as shown in FIG. 1. Accordingly, the temperature sensor 190 can be configured to provide output readings (e.g., real-time operational temperature levels, voltage fluctuations, measured indicators of circuit degradation, and/or related metrics) to the row decoder 140, which uses the temperature readings to adjust the strength and/or timing of activation signals (e.g., voltage levels) supplied to the one or more sense amplifiers 151 or a related control circuit. The temperature sensor 190 may include a negative temperature coefficient (NTC) thermistor, a resistance temperature detector (RTD), a thermocouple, a semiconductor-based temperature sensor, and/or other similar electronic circuits.

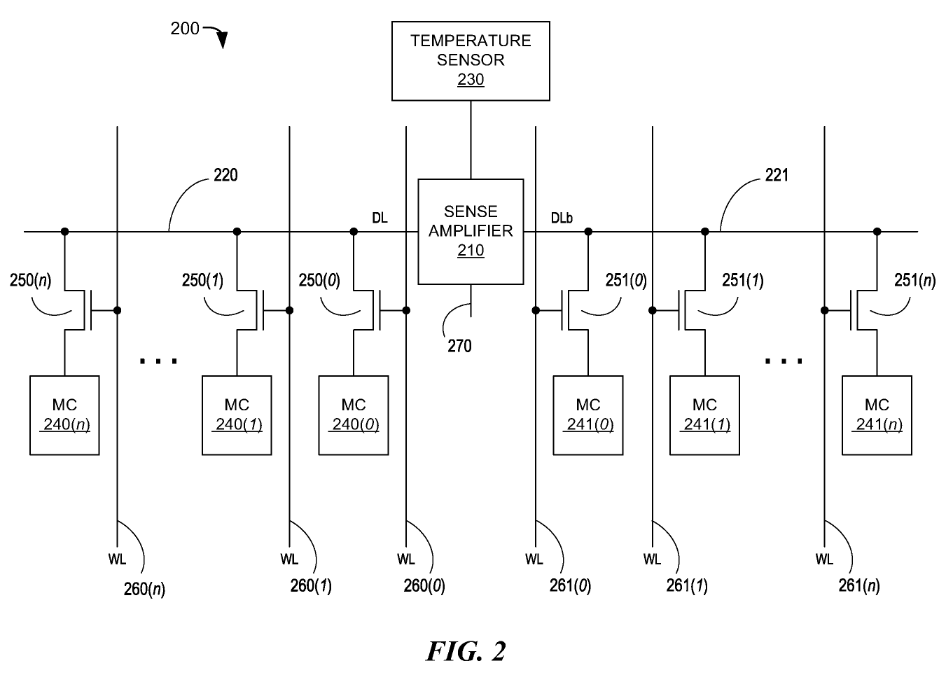

FIG. 2 is an example schematic block diagram of an example read circuit 200 in accordance with an embodiment of the present technology. In some embodiments, the apparatus 100 can include the read circuit 200 with a sense amplifier 210 (e.g., one of the sense amplifiers 151 of FIG. 1) coupled to a pair of complementary digit/bit lines DL 220 and DLb 221. As described above, a temperature sensor 230 (e.g., the temperature sensor 190 of FIG. 1) can be functionally coupled to the sense amplifier 210 (e.g., through a control logic, such as the decoder circuit).

Memory cells 240(0)-(n) may be selectively coupled through respective access devices (e.g., transistors) 250(0)-(n) to the DL 220, and memory cells 241(0)-(n) may be selectively coupled through respective access devices (e.g., transistors) 251(0)-(n) to the DLb 221. One or more sets of word-lines WL 260(0)-(n) can be configured to control the access devices 250(0)-(n), thereby selectively connecting the memory cells 240(0)-(n) to the DL 220 through the corresponding access devices 250(0)-(n). For example, the word-lines WL 260(0)-(n) can be coupled to gates of corresponding transistors and provide control signals for operating the corresponding transistors. Similarly, word-lines WL 261(0)-(n) can control the corresponding access devices 251(0)-(n) to selectively connect the memory cells 241(0)-(n) to the DLb 221. The sense amplifier 210 may be controlled via control signals received via a decoder circuit, such as the command decoder 115 of FIG. 1, the row decoder 140 of FIG. 1, the column decoder 145 of FIG. 1, and/or control circuitry of the memory cell array 150.

In some embodiments, the memory can operate according to phases or modes. For example, the memory can operate according to a first phase (e.g., precharge phase) that is initiated in response to a precharge command PRE. During the precharge phase, the word-lines WL 260(0)-(n) and 261(0)-(n) may be set to an inactive state, and in response, the access devices 250(0)-(n) and 251(0)-(n) may be disabled. Further, the digit lines DL 220 and DLb 221 may be precharged to and held at a precharge voltage, such as a digit line precharge voltage V_{BLP}, until transitioning to a second phase. The sense amplifier 210 can include internal nodes that are configured to provide a sensed data state to an output (e.g., gut nodes). During the precharge phase, the internal nodes can also be held at the precharge voltage (e.g., at V_{BLP}) until transitioning to the second phase.

In some embodiments, the sense amplifier 210 can include a threshold voltage compensation circuitry configured to compensate for threshold voltage (Vt) mismatches between components of the sense amplifier 210 during a threshold voltage compensation phase. To perform the threshold voltage compensation, the sense amplifier 210 may, during a threshold voltage compensation phase, precharge or bias the digit lines DL 220 and DLb 221 using internal nodes such that a voltage difference between the digit line DL 220 and the DLb 221 is approximately equal to threshold voltage differences between at least two circuit components of the sense amplifier 210. In some examples, the threshold voltage difference may be based on threshold voltages of transistors of the sense amplifier 210. Compensating for Vt differences between circuit components within the sense amplifier 210 can improve reliability of the apparatus 100.

The memory can operate according to a third phase (e.g., a sense amplifier activation phase) following the second phase. During the activation phase, one or more of the word-lines WL 260(0)-(n) and 261(0)-(n) may be set to an active state. In response, one or more of the access devices 250(0)-(n) and 251(0)-(n) may be enabled to couple a respective memory cell of the memory cells 240(0)-(n) and 241(0)-(n) to one of the digit lines DL 220 and DLb 221. The sense amplifier 210 may be configured to perform a sense operation to sense a data state of the coupled memory cell. That is, during a sense operation, a data state stored by the coupled memory cell is sensed and amplified by the sense amplifier 210 to drive one of the digit line DL 220 or the digit line DLb 221 to a high or low voltage level corresponding to the sensed data state. The sense amplifier 210 can drive the other digit line of the digit lines DL 220 and DLb 221 to the complementary voltage level during the sense operation.

After the sense operation, the circuitry of the memory may remain in the activation phase or may transition back to the precharge phase in response to a precharge command PRE. Similarly, one of the memory cells 241(0)-(n) can be coupled to the digit line DLb 221 through the respective access device 251(0)-(n) in response to a respective word-line 261(0)-(n) becoming active.

A data state stored by the memory cell can be sensed and amplified by the sense amplifier 210 to drive the digit line DLb 221 to a high or low voltage level corresponding to the sensed data state. The other digit line DL 220 can be driven to the complementary voltage level (e.g., the high voltage level is complementary to the low voltage level and the low voltage level is complementary to the high voltage level) during the sense operation.

As described in greater detail below, the sense amplifier 210 can utilize a variable voltage source to provide two or more voltage levels during the sense/amplification process. The variable voltage source can provide at least two voltage levels, one lower than the other. The sense amplifier 210 can use the lower voltage level during a compensation phase. Moreover, the sense amplifier 210 can use the lower voltage level during a first portion of the activation phase. The sense amplifier 210 can switch from the lower voltage level to the higher voltage level during the activation phase.

At periodic, or predetermined, time intervals (e.g., every n seconds, every m milliseconds, and/or the like), the control logic (e.g., the row decoder 140 circuit) for the sense amplifier 210 can be configured to adjust the voltage levels supplied to the sense amplifier 210 in response to fluctuating temperature readings obtained from the temperature sensor 230. For example, the row decoder 140 can probe (e.g., at the periodic time interval) a real-time operational temperature reading (e.g., of the apparatus and/or components thereof) from the temperature sensor 230 prior to execution of the operational phases of the memory. Based on the received temperature reading, the row decoder 140 can configure a variable volage source (e.g., of the voltage generator 170) to amplify (e.g. or dampen) the active voltage level supplied to the sense amplifier 210 for executing one or more of the three operational phases of the memory. For example, in response to receiving a real-time temperature reading (e.g., of the memory) that fails to satisfy an operational threshold, the row decoder 140 can configure the variable voltage source to supply an alternative precharge voltage level (e.g., at V_{BLP} + V_{TEMP}) to one or more internal nodes of the sense amplifier 210. In another example, the control logic can compare the operational temperature reading of the apparatus 100 with a stored mapping between pre-determined temperature values and/or ranges and acceptable sense voltage levels (e.g., a temperature slope) to determine an adjusted supply voltage level used to execute one or more of the three operational phases of the memory.

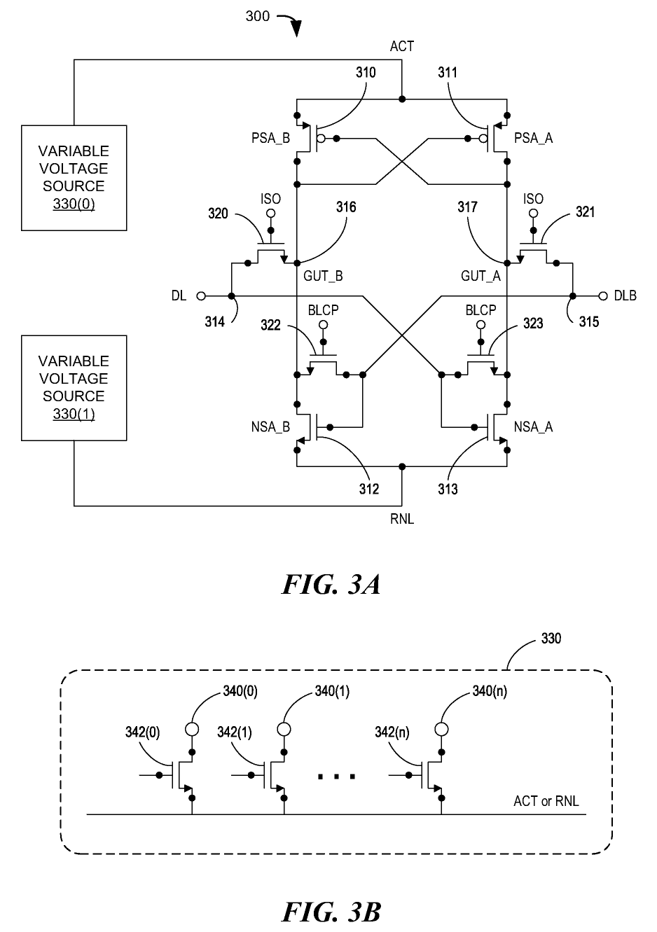

FIG. 3A is a schematic diagram of an example sense amplifier 300 (“sense amplifier 300”) in accordance with an embodiment of the present technology. The sense amplifier 300 can correspond to the sense amplifier 210 of FIG. 2 and/or one of the sense amplifiers 151 of FIG. 1.

In some embodiments, the sense amplifier 300 can include a first set of transistors (e.g., p-type field effect transistors (PFETs)) 310 and 311, each having a terminal (e.g., drains) coupled to nodes 316 and 317, respectively. Second terminals (e.g., respective gates) of the transistors 310 and 311 can be coupled to the nodes 317 and 316, respectively. Third terminals (e.g., sources) of the transistors 310 and 311 can be coupled to a power supply node ACT.

The sense amplifier 300 can further include n-type field-effect transistors (NFETS) 312 and 313 that are opposite the PFETS 310 and 311 across the nodes 316 and 317. For example, the third terminals (e.g., sources) of the transistors 312 and 313 can be coupled to a second power supply node RNL, and the first terminals (e.g., the drains) of transistors 312 and 313 can be coupled to the nodes 316 and 317, respectively. Given the connections and the function of the nodes 316 and 317, these nodes may be called “gut nodes” in a non-limiting manner.

In some embodiments, the sense amplifier 300 can include circuitry configured to mitigate the Vt mismatch that may be introduced due to process mismatch. For example, the sense amplifier 300 can include a first set of transistors (e.g., NFETs) 320 and 321 and a second set of transistors (e.g., NFETs) 322 and 323. Both sets of transistors may be coupled to the nodes 316 and 317. In one or more embodiments, the first and second sets of transistors 320-323 can be cross coupled. For example, first terminals (e.g., drains) of the transistors 320 and 322 can be coupled to the node 316. Second terminals (e.g., sources) of the transistors 321 and 323 can be coupled to the node 317. One or more of the terminals for the first set of sense transistors 320 and 321 and the second set of sense transistors 322 and 323 can be coupled to sense nodes 314 and 315. For example, a second terminal (e.g., a source) of the transistor 320 can be coupled to the node 314, and a first terminal (e.g., a drain) of the transistor 321 can be coupled to the node 315. Third terminals (e.g., gates) of the transistors 320 and 321 can be coupled to a control signal ISO that changes active/inactive states thereof. Also, a second terminal (a source) of the transistor 322, along with a terminal (e.g., a gate) of the transistor 312 can be coupled to the node 315. A first terminal (a drain) of the transistor 323, along with a terminal (e.g., a gate) of the transistor 313 can be coupled to the node 314. Third terminals (e.g., gates) of the transistors 322 and 323 can be connected to a control signal BLCP that changes active/inactive states thereof. Further, a digit line DL (e.g., the digit line DL 220 of FIG. 2) can be coupled to the node 314 and a digit line DLb (e.g., the digit line DLb 221 of FIG. 2) can be coupled to the node 315. Accordingly, the sense amplifier 300 can be configured for sampling the Vt at a set of terminals (e.g., the drains) of the first and second sets of transistors 320-323 that correspond to the digit lines DL and DLb.

In some embodiments, the sense amplifier 300 can include an equalizing transistor (e.g., an NFET; not shown) having a first terminal (e.g., a drain) and a second terminal (e.g., a source) coupled to the nodes 316 and 317, respectively. When activated by an active control signal BLEQ (e.g., high logic level), the equalizing transistor can provide a conductive path between the nodes 316 and 317, thereby equalizing the respective node voltages. The sense amplifier 300 can further include a precharge transistor (e.g., an NFET; not shown) coupled to the nodes 316 and/or 317. The precharge transistor can have a first terminal (e.g., a drain) coupled to the nodes 316 and/or 317. The precharge transistor can be configured to provide a pre-determined voltage VBLP from a second terminal (e.g., a source) to the connected nodes (e.g., the nodes 316 and/or 317) when activated by an active control signal BLP (e.g., high logic level). In some embodiments, the voltage VBLP can be provided to the nodes 316 and/or 317 when the precharge transistor is active. In some embodiments of the disclosure, the voltage VBLP can be 0.4V.

In some embodiments, the sense amplifier 300 can include one or more variable voltage sources 330 (“variable voltage source 330”) coupled to the power supply nodes (e.g., ACT and/or RNL). As shown in FIG. 3A, the sense amplifier 300 can include a first variable voltage source 330(0) that is coupled to the first power supply node ACT and a separate second variable voltage source 330(1) that is coupled to the second power supply node RNL. In another example, the sense amplifier 300 can couple a single power supply node (e.g., ACT) to a variable voltage source 330 while coupling the other power supply node (e.g., RNL) to a constant voltage source supplied via the voltage generator 170. In alternative embodiments, the sense amplifier 300 can couple the first and second power supply nodes ACT and RNL to a single variable voltage source 330. The sense amplifier 300 can configure each variable voltage source 330(0), 330(1) to supply a pre-defined number of voltage levels (e.g., at least two or more separate non-zero voltage levels) to the coupled power nodes. As a result, the variable voltage source 330 can be configured to adjust the operational voltage level of the power supply nodes (e.g., ACT and/or RNL) during, and/or prior to, execution of one or more operational phases of the sense amplifier 300.

For illustrative purposes, the transistors 310 and 311 are shown as PFETs and the transistors 312, 313, 320, 321, 322, and 323 are shown as NFETs in FIG. 3A. However, it is understood that one or more of the transistors can be a different type, connected to a different transistor, and/or connected to a different circuit without departing from the scope of the disclosure.

FIG. 3B is a schematic diagram of an example variable voltage source 330 (“variable voltage source 330”) in accordance with an embodiment of the present technology. As shown in FIG. 3B, the exemplary variable voltage source 330 can include a set of voltage sources 340(0)-(n), each configured to supply a pre-defined voltage level (e.g., a non-zero logic), and a set of transistors (e.g., n-type field effect transistors (NFETs)) 342(0)-(n), each having a terminal (e.g., sources) coupled to an individual voltage source from the set of voltage sources 340(0)-(n). Second terminals (e.g., drains) of the transistors 342(0)-(n) can be coupled to a power supply node (e.g., ACT or RNL) of the sense amplifier 300. The transistors 342(0)-(n) can be configured to provide a pre-defined voltage levels of a voltage source 340(0)-(n) from a first terminal (e.g., a source) to the connected power supply nodes (e.g., ACT and/or RNL) when activated by an active control signal (e.g., high logic level) at the respective gate terminals.

In some embodiments, the voltage source 330 can be configured to provide different pre-defined voltage levels to the power supply nodes based on selective activation and/or deactivation of the transistors 342(0)-(n). For example, the variable voltage source 330 can activate a first transistor 342(0) to provide a conductive path between a first voltage source 340(0) and the power supply nodes while the remaining transistors 342(1)-(n) are deactivated. Accordingly, the first voltage source 340(0) can provide a first pre-defined voltage level to the power supply nodes. In a further example, the variable voltage source 330 can deactivate the first transistor 342(0) to remove the conductive path between the first voltage source 340(0) and the power supply notes while simultaneously activating a second transistor 342(1) to provide a conductive path between a second voltage source 340(1) and the power supply nodes. As a result, the second voltage source 340(1) can provide a second pre-defined voltage level (e.g., different from the first pre-defined level) to the power supply nodes.

In some embodiments, the variable voltage source 330 can include a passive linear circuit (e.g., a voltage divider) that is configured to provide an output voltage level (e.g., to the power supply nodes) that is a fraction of the pre-defined voltage level of a single voltage source 340. For example, the variable voltage source 330 can include a single voltage source 340 coupled to a linear array of passive electrical components of pre-defined electrical resistance (e.g., resistors), each having terminals coupled to intermediary nodes of the linear array. The intermediary nodes can be coupled to the first terminals (e.g., sources) of the transistors 342(0)-(n), each providing a unique fractional voltage level of the pre-defined voltage level of the single voltage source 340 to the transistors 342(0)-(n). As an illustrative example, the variable voltage source 330 can include a voltage divider with selectively accessible tap points that each provide a unique voltage level.

For illustrative purposes, the transistors 342(0)-(n) are shown as NFETs in FIG. 3B. However, it is understood that one or more of the transistors can be a different type, connected to a different transistor, and/or connected to a different circuit without departing from the scope of the disclosure. Furthermore, it is understood that the schematic design for the variable voltage source 330 can be implemented via alternative circuit configurations without departing from the scope of the disclosure.

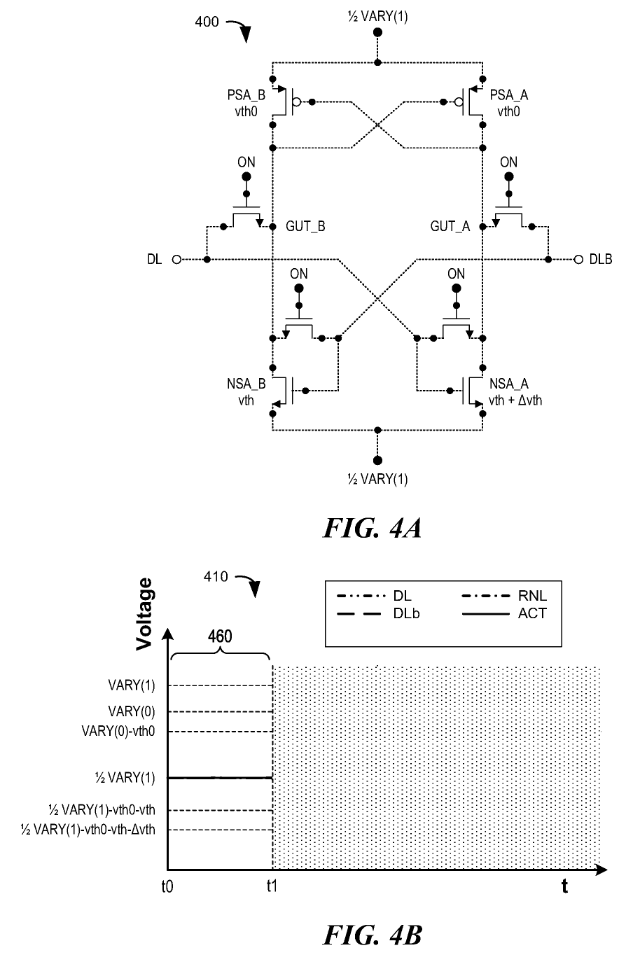

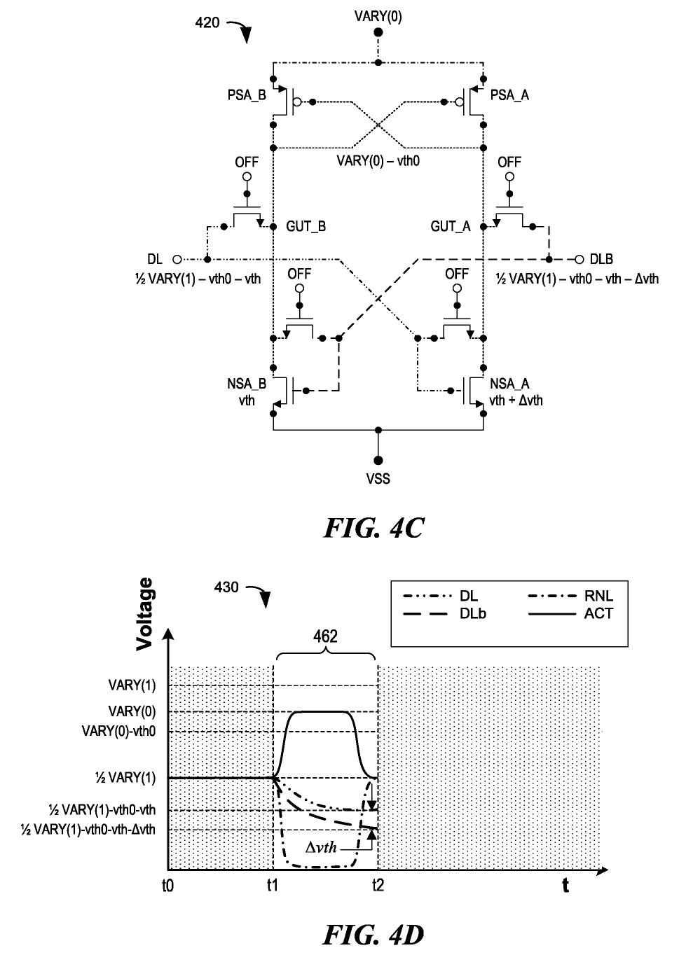

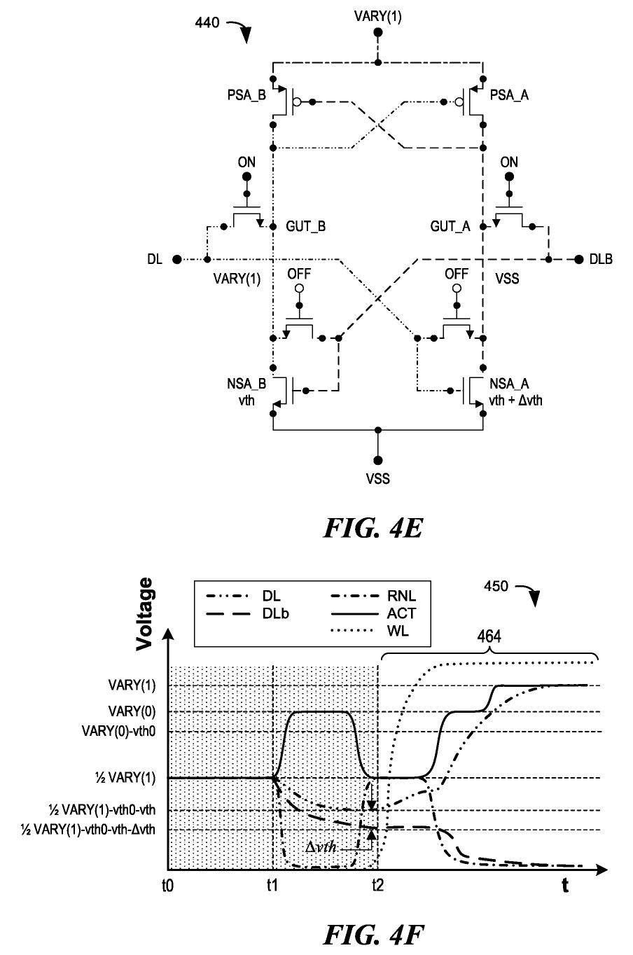

As described above, operation of the sense amplifier 300 can include multiple phases, and the variable voltage source can provide different voltage levels across the multiple phases. The various phases are illustrated across FIG. 4A-4F. For simplicity, the various phases are described below using two voltage levels, VARY(0) and VARY(1), that correspond to an intermediate restoration voltage level and a final restoration voltage level respectively. The intermediate restoration voltage level (VARY(0)) can be lower than the restoration voltage level (VARY(1)).

For illustrating a first operational phase 460 (e.g., between t0 and t1 of FIG. 4B), FIG. 4A is a circuit diagram of the example sense amplifier 300 of FIG. 3A in a first state 400, and FIG. 4B is a timing diagram 410 for the first state 400, both in accordance with an embodiment of the present technology. Referring to FIGS. 4A and 4B together, the first state 400 and the timing diagram 410 can illustrate voltages at various portions within the sense amplifier 300, such as for the nodes 314 and 315 of FIG. 3A (e.g., the digit lines DL and DLb) and/or for the nodes 316 and 317 of FIG. 3A (e.g., the gut nodes A and/or B), during the first operational phase 460 (“first phase 460”).

In some embodiments, the first phase 460 (e.g., between t0 and t1) can correspond to a precharge phase. Prior to the initial portion (e.g., at t0) of the first phase 460, the nodes 314 and 315 corresponding to the digit lines DL and DLB can be at complementary levels. For example, one of the digit lines can be at a high voltage level (e.g., VARY(1) or VDD) and the other of the digit lines can be at a low voltage level (e.g., VSS or ground). Further, the voltages at the gut nodes 316 and 317 can be at complementary levels. For example, one of the nodes 316 or 317 can be at a higher voltage (e.g., VARY(1)) and the other can be at a lower voltage (e.g., VSS).

At the initial portion of the first phase 460, the power supply nodes ACT and RNL can be set to an initial voltage level (e.g., ½ VARY(1)) to equalize the digit line voltage levels. As a result, the nodes 314, 315, 316, and 317 can be set to the initial voltage level ½ VARY(1), as illustrated in FIG. 4B. In some embodiments, the voltages at the gut nodes can be independent of or separate from the voltages at the nodes 314 and node 315 at and/or before t0. In some embodiments, the voltage VARY may be a static voltage level, such as 1.0V. In some embodiments, the voltage VARY may include a set of intermediate voltage levels VARY(0)-(n) within the maximum voltage capacity V_{MAX} of the variable voltage source 330. For example, the voltage VARY may include a lower voltage level VARY(0) (e.g., ~ 0.7 V) and a higher voltage level VARY(1) (e.g., ~ 0.9 V), as illustrated in FIG. 4B.

In some embodiments, a set of terminals (e.g., the gate and the drain) of the transistor 312 can be coupled together and a set of terminals (e.g., the gate and the drain) of the transistor 313 can be coupled together. Accordingly, the transistors 312 and 313 can effectively be diode coupled. In some embodiments, the control signal ISO can activate the transistors 320 and 321 of FIG. 3A, thereby electrically connecting the nodes 314 and 315 to the nodes 316 and 317, respectively. Accordingly, the nodes 314 and 315 can have the same voltage level as the nodes 316 and 317.

In an alternative embodiment, during the first phase 460 (e.g., at or after t0), the precharge transistor of the sense amplifier 300 can be activated via an active control signal BLP to provide a voltage VBLP to nodes 316 and/or 317 of FIG. 3A. The control signal BLEQ can activate the equalizing transistor to form a conductive path between the nodes 316 and 317. Thus, according to the BLEQ signal, the gut nodes can be equalized (e.g., causing the nodes 316 and 317 to have the same voltage levels, such as VBLP).

In illustrating a second operational phase 462 (e.g., between t1 and t2 of FIG. 4D), FIG. 4C is a circuit diagram of the example sense amplifier 300 of FIG. 3A in a second state 420, and FIG. 4D is a timing diagram 430 for the second state 420, both in accordance with an embodiment of the present technology. Referring to FIGS. 4C and 4D together, the second state 420 and the timing diagram 430 can illustrate voltages at various portions within the sense amplifier 300, such as for the nodes 314 and 315 of FIG. 3A (e.g., the digit lines DL and DLb) and/or for the nodes 316 and 317 of FIG. 3A (e.g., the gut nodes A and/or B), during the second operational phase 462 (“second phase 462”).

In some embodiments, the second phase 462 (e.g., between t1 and t2) can correspond to a Vt compensation phase. During the second phase 462, the control signal ISO can deactivate the transistors 320 and 321 to no longer provide a conductive path between the sense nodes 314 and 315 and the nodes 316 and 317, respectively. As a result, the nodes 314 and 315 can be isolated from the nodes 316 and 317. Also, following time t1, the voltage provided to the power supply node ACT can change from the initial voltage level (e.g., ½ VARY(1)) to a higher voltage level (e.g., VARY(0)) and the voltage provided to the power supply node RNL can change from the initial voltage level (e.g., ½ VARY(1)) to a lower voltage level (e.g., VSS), as shown in FIG. 4D. Accordingly, the voltage at the nodes 316 and 317 can change based on the VARY(0) voltage being provided to the power supply node ACT. The voltage of the nodes 316 and 317 can change to VARY(0) – vth0 due to a voltage drop across the transistors 310 and 311. The value vth0 can correspond to the threshold voltage of the transistors 310 and 311. It is assumed for the example that a threshold voltage vth0 of the transistors 310 and 311 is greater than a threshold voltage vth1 of the equalizing transistor. In some embodiments of the disclosure, the threshold voltage vth0 can be 0.25V. In an alternative embodiment, the precharge transistor can be deactivated during the second phase 462 according to the BLP signal, thus no longer providing the voltage VBLP to the nodes 316 and/or 317.

In some embodiments, the Vt mismatches resulting from process, voltage, and temperature (PVT) and/or can cause a difference between the respective voltages at nodes 314 and 315. With the power supply node RNL at the low voltage level (e.g., VSS) and the control signal ISO deactivating the transistors 320 and 321, the voltage at the node 314 can be the gate voltage (e.g., ½ VARY(1)) less the threshold voltage of the transistor 312 (vth). Similarly, the voltage at the node 315 can be the gate voltage (e.g., ½ VARY(1)) less the threshold voltage of the transistor 313 (vth + Δvth). The resulting voltage at node 314 can be represented as (½ VARY(1) – vth0) – vth and the resulting voltage at node 315 can be represented as (½ VARY(1) – vth0) – (vth + Δvth). The voltage at the node 314 may be rewritten as ½ VARY(1) – vth0 – vth and the voltage at node 315 may be rewritten as ½ VARY(1) – vth0 – vth – Δvth. The resulting voltages at the nodes 314 and 315 can causes the voltages of the digit lines DL and DLb, respectively, to change. For the example illustrated in FIG. 4D, the voltage of digit line DL is greater than the voltage of digit line DLb (e.g., the voltage of node 314 is greater than the voltage of node 315) by the voltage difference of nodes 314 and 315 Δvth. The difference between the respective voltages of nodes 314 and 315 (e.g., Δvth) can represent a threshold voltage offset between the threshold voltages of the transistors 312 and 313. By causing the respective voltages at nodes 314 and 315, threshold voltage compensation (e.g., for the transistors 312 and 313) may be provided.

In some embodiments, the second phase 462 can include an equalization phase. For example, following time t1, the voltage supplied to the power supply nodes (e.g., ACT and RNL) can be set to the initial voltage level (e.g., ½ VARY(1)), as illustrated in FIG. 4D. Further, the equalizing transistor can be activated to provide a conductive path between nodes 316 and 317. As a result, the voltage level at nodes 316 and 317 can be set to the initial voltage level (e.g., ½VARY(1)) by the start of the third operational phase (e.g., before t2). In additional or alternative embodiments, the precharge transistor may be activated to provide the voltage VBLP to the node 317. The voltage provided to the power supply node ACT may also change from the higher voltage level VARY(0) to the voltage VBLP. With the equalizing transistor still activated to provide a conductive path between nodes 316 and 317, the voltage at nodes 316 and 317 may change to the voltage VBLP by time t2. The respective voltages at nodes 314 and 315 can be independent of the change in voltage at nodes 316 and 317. Thus, the difference in respective voltages remains at nodes 316 and 317 for threshold voltage compensation.

In illustrating a third operational phase 464 (e.g., after t2 of FIG. 4F), FIG. 4E is a circuit diagram of the example sense amplifier 300 of FIG. 3A in a third state 440, and FIG. 4F is a timing diagram 450 for the third state 440, both in accordance with an embodiment of the present technology. Referring to FIG. 4E and FIG. 4F together, the third state 440 and the timing diagram 450 can illustrate voltages at various portions within the sense amplifier 300, such as for the nodes 314 and 315 of FIG. 3A (e.g., the digit lines DL and DLb) and/or for the nodes 316 and 317 of FIG. 3A (e.g., the gut nodes A and/or B), during the third operational phase 464 (“third phase 464”).

In some embodiments, the third phase 464 (e.g., after t2) can correspond to an operational phase for sensing a bit line signal (e.g., stored memory cell signal). Effectively, the sense amplifier 300 can be coupled to a memory cell (e.g., one of the memory cells illustrated in FIG. 2) via the digit line DL or DLb to read the information stored in the connecting memory cell. The memory cell coupled to the digit line can cause a voltage change on the respective digit line based on the state (e.g., the stored charges) of the connected memory cell. The sense amplifier 300 can determine the voltage change, thereby reading the information stored in the connecting memory cell. For example, at the initial portion of the third phase 464 (e.g., around t2), a targeted word-line can be activated, thereby connecting a corresponding memory cell to the sense amplifier 300 through the digit line DL or DLb. For the example illustrated in FIG. 4F, the voltage at the digit line DL (e.g., node 314) can increase, such as by V_{sig} according to the connected memory cell. Also, after t2, the control signal ISO can activate the transistors 320 and 321, thereby connecting the node 316 to the node 314 and connecting the node 317 to the node 315. Accordingly, the resulting voltage at the node 314 can be represented as ½VARY(1) – vth0 – vth + V_{sig}. The voltage at the node 315 can remain at ½VARY(1) – vth0 – vth – Δvth.

After activation of the targeted word-line (e.g., after t2), the voltage provided to the power supply nodes (e.g., ACT and RNL) can be changed to amplify the received voltage signal (e.g., V_{sig}) of the memory cell. For example, the voltage supplied to the power supply node ACT can be changed from the initial voltage level (e.g., ½VARY(1)) to the intermediate restoration voltage level (e.g., VARY(0)). Further, the voltage supplied to the power supply node RNL can be changed from the initial voltage level (e.g., ½VARY(1)) to the lower voltage level (e.g., VSS). As a result, the increased voltage at the digit line DL (e.g., node 314) can cause the voltage levels for the digit lines DL and DLb to diverge towards complementary voltage levels (e.g., VSS and VARY(0)), as shown in FIG. 4F.

In some embodiments, the third phase 464 can include an intermediary phase for adjusting the supplied voltage level of the power supply node ACT. At some time after t2, the variable voltage source 330 of the sense amplifier 300 can be configured to provide the higher restoration voltage level (e.g., VARY (1)) to the power supply node ACT. As a result, the sense amplifier 300 can further increase the voltage of the gut node with the bit line signal (e.g., V_{sig}). For the example illustrated in FIG. 4F, the voltage at the digit line DL (e.g., node 314) can further increase by the voltage difference VARY(1) – VARY(0). Accordingly, the resulting voltage at the node 314 can be represented as VARY(1) – vth0 – vth + V_{sig}. The voltage at the node 315 can remain at ½VARY(1) – vth0 – vth – Δvth. Although FIGS. 4A-4F only depict an operation transitioning from an intermediate restoration voltage level (e.g., VARY(0)) to a restoration voltage level (e.g., VARY(1)), the embodiments of the described sense amplifier 300 and/or the variable voltage source 330 is not limited to two supplied voltages for the power supply nodes (e.g., ACT). For example, as the third phase 464 progresses after t3, the variable voltage source 330 of the sense amplifier 300 can be configured to provide a set/sequence of increasing voltages (e.g., VARY(1)-(n)) to the power supply node ACT. In some embodiments, the intermediate restoration voltage level (e.g., VARY(0)) may be called “the intermediate voltage level” or “the intermediate read voltage” in a non-limiting manner. In some embodiments, the restoration voltage level (e.g., VARY(1)) may be called “the target voltage level” or “the target read voltage” in a non-limiting manner.

By gradually increasing the voltage of the power supply node ACT during the third phase 464, the sense amplifier 300 of FIG. 3A can minimize the strength and/or speed by which the memory cell signal (e.g., V_{sig}) is read (e.g., under drive of the power supply nodes), thereby providing advantages over other sense amplifiers. For example, the sense amplifier 300 can provide, at each time instance during the third phase 464, the minimum required voltage to the power supply node ACT for increasing the memory cell signal, which reduces intermediate voltage fluctuations (e.g., reduced voltage rate and/or volatility) as the voltage of the power supply node ACT increases from the initial supplied voltage (e.g., VARY(0)) to the highest supplied voltage (e.g., VARY(1)). As a result, the sense amplifier 300 can determine granular voltage changes on the digit line, providing improved sense accuracy for smaller memory cells (e.g., small cell capacitance) when compared to existing sense amplifiers.

For illustrative purposes, the intermediary phase is shown as increasing voltage levels for the power supply node ACT in FIG. 4F. However, it is understood that the intermediary phase can also include adjustments to the supplied voltage for the power supply node RNL without departing from the scope of the disclosure. For example, when changing the voltage level for the power supply node RNL from the initial voltage level (e.g., ½VARY(1)) to the lower voltage level (e.g., VSS), the variable voltage source 330 of the sense amplifier 300 can drop the voltage supplied to the power supply node RNL to a first low voltage level VSS(0) (e.g., between ½VARY(1) and VSS). The variable voltage source 330 can further change the voltage supplied to the power supply node RNL from the first low voltage level VSS(0) to a subsequent low voltage level VSS(1) (e.g., between VSS(0) and VSS) that is closer to the minimum voltage level (e.g., VSS).

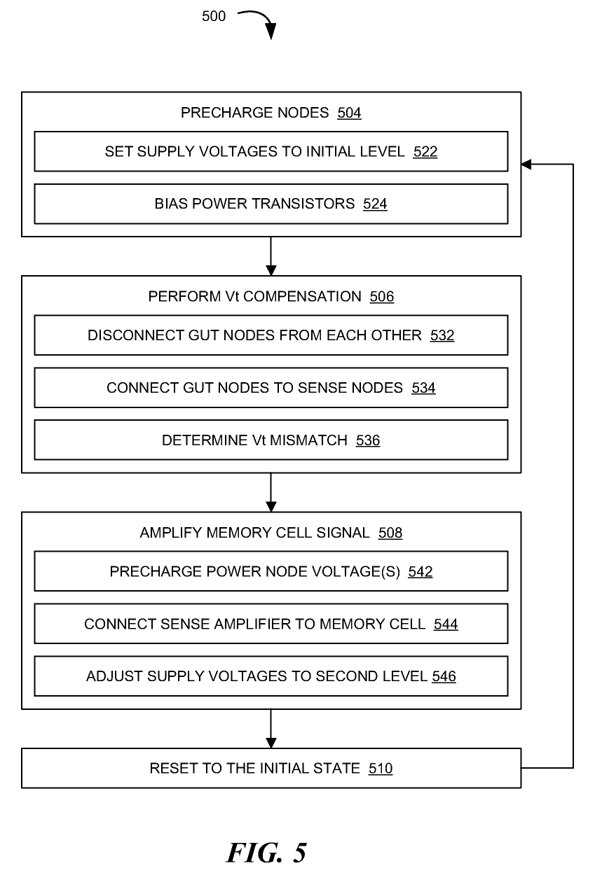

FIG. 5 is a flow diagram illustrating an example method of operating an apparatus (e.g., the apparatus 100 of FIG. 1) in accordance with an embodiment of the present technology. For example, the method 500 can be for operating the sense amplifier 151 of FIG. 1, the sense amplifier 210 of FIG. 2, and/or the example sense amplifier 300 of FIG. 3A as described above. The method 500 can be for dynamically adjusting the supplied voltage to one or more nodes within the apparatus (e.g., the power supply nodes ACT and/or RNL of FIG. 3A) when reading information from memory cells coupled to the apparatus. For example, the method 500 can be for implementing the first phase 460, the second phase 462, and the third phase 464 illustrated in FIGS. 4B, 4D and 4F.

As described above, the initial state (e.g., prior to t0 illustrated in FIG. 4B) of the sense amplifier 300 can correspond to an end of the preceding operation (e.g., the end of the third phase 464). Accordingly, the gut nodes can be disconnected from corresponding sense nodes (e.g., the nodes 314 and 315 corresponding to DL and DLb, respectively), such as by deactivating the isolation transistors (e.g., the transistors 320 and 321 of FIG. 3A), thereby removing the corresponding direct connections between the nodes 314 and 316 and between the nodes 315 and 317, respectively. The gut nodes and/or the corresponding sense nodes can have complementary voltage levels (e.g., VARY(1)-(n) and VSS). In some embodiments, the gut nodes (e.g., nodes 316 and 317) can also be decoupled from each other, such as by deactivating an equalizing transistor that is directly connected between the gut nodes.

In some embodiments, the apparatus 100 can equalize the gut node voltages by activating a precharge transistor to supply a pre-determined voltage (e.g., VBLP) to nodes 316 and/or 317 of the apparatus. In some embodiments, the apparatus 100 can activate an equalizing transistor to equalize the voltages at nodes 316 and 317.

At block 504, the apparatus 100 can precharge one or more nodes of the sense amplifier (e.g., gut and/or sense nodes). For example, at block 522, the apparatus 100 can supply an initial voltage level (e.g., ½VARY(1)) to the power supply nodes (e.g., ACT and RNL) to settle the voltages at the gut nodes and/or sense nodes approximately halfway between the complementary voltage levels and/or the restoration voltage level (e.g., VARY(1)). In some embodiments, the apparatus 100 can equalize the gut node voltages by activating a precharge transistor to supply a pre-determined voltage (e.g., VBLP) to nodes 316 and/or 317 of the apparatus. In some embodiments, the apparatus 100 can activate an equalizing transistor to equalize the voltages at nodes 316 and 317.

At block 524, the apparatus 100 can bias the power transistors. In other words, the apparatus 100 can self-bias the transistors 310, 311, 312, and/or 313 based on increasing the power node voltages. Accordingly, apparatus 100 can precharge one or more of the corresponding nodes. For example, the apparatus 100 can precharge the gut nodes and/or the sense nodes (e.g., the nodes 314, 315, 316, and/or 317) based on biasing the power transistors. As described above, in some embodiments, the gut nodes can be precharged to ½VARY(1) – vth0 and the sense nodes can be precharged to ½VARY(1) – vth0 – vth and ½VARY(1) – vth0 – vth – Δvth.

Blocks 504, 522, and 524 can correspond to the first phase 460 of FIG. 4B and the second phase 462 of FIG. 4D. The following blocks and the corresponding processes can correspond to the third phase 464.

At block 506, the apparatus 100 can perform the Vt compensation phase for the sense amplifier components. For example, at block 532, the apparatus 100 can disconnect the gut nodes (e.g., the nodes 316 and 317) from each other. In some embodiments, the apparatus 100 can deactivate an equalizing transistor to remove a direct connection between the gut nodes. Accordingly, the voltages at the gut nodes can be independent of each other. In some embodiments, the apparatus 100 can deactivate a precharge transistor to stop supply of the pre-determined intermediary voltage (e.g., ½VARY(1), or VBLP) to the nodes 316 and/or 317.

At block 534, the apparatus 100 can connect the gut nodes to corresponding sense nodes. For example, the apparatus 100 can activate the isolating transistors (e.g., the transistors 320 and 321) to provide a direct electrical connection between the nodes 314 and 316 and/or between the nodes 315 and 317, respectively.

At block 536, the apparatus 100 can determine the Vt mismatch between components. In some embodiments, the apparatus 100 can sample the voltages at the gut nodes and/or the sense nodes. The apparatus 100 can determine the Vt mismatch (e.g., Δvth) between transistors 312 and 313 based on comparing the voltages of the gut nodes and/or based on comparing the voltages of the sense nodes. In some embodiments, the apparatus 100 can determine the Vt mismatch before block 536, such as based on sampling and comparing the voltages at the sense nodes.

At block 508, the apparatus 100 can generate an amplified output of the sense amplifier to read information stored in a coupled memory cell. For example, at block 542, the apparatus 100 can drive the power supply node ACT to the intermediate restoration voltage (e.g., VARY(0)) and the power supply node RNL to a low voltage (e.g., VSS). The apparatus 100 can decrease the voltage level for the power supply node RNL based on disconnecting a supply circuit from the corresponding node, reducing an output of the supply circuit, and/or connecting the node to a lower potential (e.g., VSS).

At block 544, the apparatus 100 can connect the sense amplifier to one of the memory cells. For example, the apparatus 100 can activate one of the word-lines in FIG. 2 to connect one of the memory cells to the digit line DL or the digit line DLb. Accordingly, the voltage at the corresponding sense node can be increased based on the connection. As described above, the voltages at the sense nodes and the connected gut nodes can be represented as VARY(0) – vth0 – vth + Vsig for the node connected to the memory cell and ½VARY(1) – vth0 – vth – Δvth for the unconnected sense node. Based on one or more of the above-described operations, the sense amplifier 400 can generate an amplified output that represents a level of stored charges (e.g., stored information) in the connected memory cell.

At block 546, the apparatus 100 can adjust (e.g., increase) the provided voltage for the power supply node ACT from the intermediate restoration voltage level to a restoration voltage level. For example, the apparatus 100 can increase the voltage level at the ACT power supply node from VARY(0) to VARY(1) during the operation of the sense amplifier (e.g., after t2 of FIG. 4F). Accordingly, the voltage at the corresponding sense node connected to the memory cell can be increased from VARY(0) – vth0 – vth + Vsig to VARY(1) – vth0 – vth + Vsig. In one or more embodiments, the apparatus 100 can iteratively increase the voltage level at the ACT power supply node from the intermediate restoration voltage level, such as VARY(0), up to the restoration voltage level, such as VARY(n). By gradually increasing the voltage level at the ACT power supply node, the apparatus 100 can dampen the rate and/or volatility at which the voltage at the corresponding sense node increases. In one or more embodiments, the apparatus 100 may variably increase the voltage level at the power supply nodes based on connecting the nodes to one or more power supplies capable of increasing voltage outputs, such as a variable voltage source described above.

In some embodiments, the apparatus 100 can further adjust, or trim, the voltage levels (e.g., initial, intermediate restoration, and/or restoration voltage levels) provided to the power supply nodes (e.g., ACT and/or RNL) based on one or more sensor readings of the operational environment. For example, the apparatus 100 can receive real-time temperature output readings from one or more temperature sensors coupled to the sense amplifier. Accordingly, the apparatus 100 can compare the received temperature reading to a stored mapping (e.g., a lookup table) between temperature values, or ranges, and pre-determined voltage levels to determine the appropriate voltages prior to executing one or more operational phases 460, 462, 464.

At block 510, the apparatus 100 can reset the sense amplifier 300 to the initial state. For example, the apparatus 100 can deactivate the wordline, thereby disconnecting the memory cell from the sense amplifier. Further, the apparatus 100 can deactivate the isolation transistors (e.g., the transistors 320 and 321), thereby isolating gut nodes from corresponding sense nodes. In other words, the apparatus 100 can sever the connection between the nodes 314 and 316 and between the nodes 315 and 317. As represented by the feedback loop, the apparatus 100 can repeat the above-described method 800 for subsequent read operations.

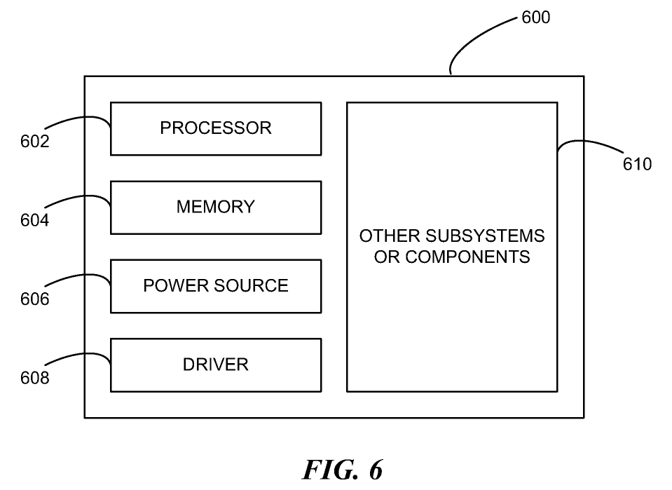

FIG. 6 is a schematic view of a system that includes an apparatus in accordance with embodiments of the present technology. Any one of the foregoing apparatuses (e.g., memory devices) described above with reference to FIGS. 1-5 can be incorporated into any of a myriad of larger and/or more complex systems, a representative example of which is system 600 shown schematically in FIG. 6. The system 600 can include a processor 602, a memory device 604, a power source 606, a driver 608, and/or other subsystems or components 610.

The memory device 604 can include features generally similar to those of the apparatus described above with reference to FIGS. 1-5 and can therefore include various features for performing a direct read request from a host device. The resulting system 600 can perform any of a wide variety of functions, such as memory storage, data processing, and/or other suitable functions. Accordingly, representative systems 600 can include, without limitation, hand-held devices (e.g., mobile phones, tablets, digital readers, and digital audio players), computers, vehicles, appliances and other products. Components of the system 600 may be housed in a single unit or distributed over multiple, interconnected units (e.g., through a communications network). The components of the system 600 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of DRAM devices. Apparatuses configured in accordance with other embodiments of the present technology, however, can include other types of suitable storage media in addition to or in lieu of DRAM devices, such as, devices incorporating NAND-based or NOR-based non-volatile storage media (e.g., NAND flash), magnetic storage media, phase-change storage media, ferroelectric storage media, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or implementation occurring during operation, usage or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to FIGS. 1-6.

### FURTHER EXAMPLES

In some embodiments, the techniques described herein relate to an apparatus including: a memory cell configured to store charges representative of a data value; a first power source configured to provide a target voltage corresponding to a restoration voltage used in amplifying the stored charges for reading the data value; a second power source configured to provide an intermediate restoration read voltage that is less than the target read voltage, wherein the intermediate restoration voltage corresponds to a different voltage used in amplifying the stored charges for reading a data value represented by the stored charges; and a sense amplifier coupled to the memory cell and the first and the second power sources, the sense amplifier configured to amplify the charges stored in the memory cell for reading the data value, wherein the sense amplifier is configured to use the intermediate read voltage and then the target read voltage in amplifying the charges.

In some embodiments, the techniques described herein relate to an apparatus, further including: a connection relay disposed between the memory cell and the sense amplifier and configured to selectively couple the sense amplifier to the memory cell for reading the data value from the memory cell; and wherein: the sense amplifier is configured to use the intermediate restoration voltage for a threshold voltage compensation (VTC) phase that occurs before the connection relay is activated to connect the sense amplifier to the memory cell, wherein the VTC phase is implemented to prepare the sense amplifier to actively amplifying the stored charges.

In some embodiments, the techniques described herein relate to an apparatus, wherein the target voltage is equivalent to a voltage used to write data into the memory cell.

In some embodiments, the techniques described herein relate to an apparatus, wherein the sense amplifier is configured to: use the second power source to initially amplify the stored charges during a sensing phase that actively amplifies the stored charges; and use the first power source after the second power source to further amplify the stored charges in actively amplifying the stored charges.

In some embodiments, the techniques described herein relate to an apparatus, wherein the sense amplifier is configured to change from the second power source to the first power source according to a timing that corresponds to a difference between the intermediate read voltage and the target read voltage.

In some embodiments, the techniques described herein relate to an apparatus, wherein: the sense amplifier includes a sense node; amplifying the stored charges corresponds to amplifying a voltage at the sense node using the second and the first power sources; and the timing for changing from the second power source to the first power source corresponds to an estimated timing of when voltage at the sense node matches or is within a threshold range of the intermediate read voltage.

In some embodiments, the techniques described herein relate to an apparatus, wherein the intermediate restoration voltage is at least half of the target read voltage.

In some embodiments, the techniques described herein relate to an apparatus, wherein the sense amplifier is configured to implement a threshold voltage compensation (VTC) phase using the intermediate read voltage from the second power source wherein: the VTC phase occurs before the sensing phase, and the VTC phase includes providing the intermediate read voltage to one or more internal nodes within the sense amplifier to compensate for threshold voltage of one or more transistors used during the sensing phase and/or in transitioning from the VTC phase to the sensing phase.

In some embodiments, the techniques described herein relate to an apparatus, further including: a sensor coupled to the sense amplifier that is configured to provide one or more output readings that measures an operating condition of the apparatus; and wherein the sense amplifier is configured to adjust the intermediate read voltage prior to amplifying the charges stored in the memory cell when the one or more output readings from the sensor fail to satisfy an operational threshold.

In some embodiments, the techniques described herein relate to a method of operating an apparatus, the method including: operating a sense amplifier to amplify charges stored in a memory cell using an intermediate restoration voltage; operating the sense amplifier to amplify the stored charges using a target voltage that is greater than the intermediate restoration voltage; and reading a data value represented by the stored charges using the amplified result thereof.

In some embodiments, the techniques described herein relate to a method, wherein: a connection relay is disposed between the memory cell and the apparatus and configured to selectively couple the apparatus to the memory cell for reading the data value from the memory cell; the target read voltage corresponds to a restoration voltage level used in amplifying the stored charges to one or more targeted levels in reading the data value; and the method further including: performing, using the intermediate read voltage, a threshold voltage compensation (VTC) before the connection relay is activated to connect the apparatus to the memory cell, wherein performing the VTC includes preparing the sense amplifier to actively amplify the stored charges.

In some embodiments, the techniques described herein relate to a method, wherein the target read voltage is equivalent to a voltage used to write data into the memory cell.

In some embodiments, the techniques described herein relate to a method, further including: operating a connection relay to communicatively couple the sense amplifier to the memory cell for reading the data value from the memory cell; and wherein: operating the sense amplifier to amplify the stored charges using the intermediate restoration voltage includes amplifying the stored charges to an initial magnitude; and operating the sense amplifier to amplify the stored charges using the target voltage includes amplifying the stored charges from the initial magnitude to a restoration magnitude used for reading the data value.

In some embodiments, the techniques described herein relate to a method, further including: providing the intermediate restoration voltage from a first power source in preparation for operating the sense amplifier using the intermediate restoration voltage; providing the target voltage from a second power source according to a timing that corresponds to a difference between the intermediate read voltage and the target read voltage.

In some embodiments, the techniques described herein relate to a method, wherein: the apparatus includes a sense node connected to the connection relay, wherein amplifying the stored charges corresponds to amplifying a voltage at the sense node using the first and second power sources; and the timing for changing from the second power source to the first power source corresponds to an estimated timing of when voltage at the sense node matches or is within a threshold range of the intermediate read voltage.

In some embodiments, the techniques described herein relate to a memory device, including: memory cells each configured to store charges representative of one or more data values; a first digit line DL coupled to a first set of the memory cells; a second digit line DLb coupled to a second set of the memory cells; a sense amplifier coupled to the first digit line DL and the second digit line DLb, the sense amplifier configured to amplify voltages on the first digit line DL and/or the second digit line DLb for reading the one or more data values stored in the memory cells, wherein the voltages correspond to the charges stored in the memory cells, wherein the sense amplifier is configure to amplify the voltages using an intermediate restoration voltage supplied and then a target voltage, wherein the target read voltage is greater than the intermediate read voltage.

In some embodiments, the techniques described herein relate to a memory device, wherein the sense amplifier is configured to change from the intermediate restoration voltage to the target voltage according to a timing that corresponds to a difference between the intermediate restoration voltage and the target voltage.

In some embodiments, the techniques described herein relate to a memory device, wherein: the sense amplifier includes a sense node connected to the first digit line DL and/or the second digit line DLb; amplifying the voltages on the first digit line DL and/or the second digit line DLb includes amplifying the voltage at the sense node using the intermediate and target voltages; and the timing for changing from the intermediate restoration voltage to the target voltage corresponds to an estimated timing of when the voltage at the sense node matches or is within a threshold range of the intermediate read voltage.

In some embodiments, the techniques described herein relate to a memory device, wherein: using the intermediate restoration voltage and then the target voltage to amplify the stored charges that correspond to a sensing phase; and the sense amplifier is configured to implement a threshold voltage compensation (VTC) phase using the intermediate read voltage, wherein the VTC phase occurs before the sensing phase, and wherein the VTC phase includes providing the intermediate read voltage to one or more internal nodes within the sense amplifier to compensate for threshold voltage of one or more transistors used during the sensing phase and/or in transitioning from the VTC phase to the sensing phase.

In some embodiments, the techniques described herein relate to a memory device, further including: a sensor coupled to the sense amplifier that is configured to provide one or more output readings that measures operating condition of the memory device; and wherein the sense amplifier is configured to adjust the intermediate read voltage prior to amplifying the voltages on the first digit line DL and/or the second digit line DLb when the one or more output readings from the sensor fail to satisfy an operational threshold.

We claim:

1. An apparatus comprising:
a memory cell configured to store charges representative of a data value;
a first power source configured to provide a target voltage corresponding to a restoration voltage used in amplifying the stored charges for reading the data value;
a second power source configured to provide an intermediate read voltage that is less than the target read voltage, wherein the intermediate restoration voltage corresponds to a different voltage used in amplifying the stored charges for reading a data value represented by the stored charges; and
a sense amplifier coupled to the memory cell and the first and the second power sources, the sense amplifier configured to amplify the charges stored in the memory cell for reading the data value, wherein the sense amplifier is configured to use the intermediate read voltage and then the target read voltage in amplifying the charges.

2. The apparatus of claim 1, further comprising:
a connection relay disposed between the memory cell and the sense amplifier and configured to selectively couple the sense amplifier to the memory cell for reading the data value from the memory cell; and
wherein:
the sense amplifier is configured to use the intermediate restoration voltage for a threshold voltage compensation (VTC) phase that occurs before the connection relay is activated to connect the sense amplifier to the memory cell, wherein the VTC phase is implemented to prepare the sense amplifier to actively amplifying the stored charges.

3. The apparatus of claim 1, wherein the target voltage is equivalent to a voltage used to write data into the memory cell.

4. The apparatus of claim 1, wherein the sense amplifier is configured to:
use the second power source to initially amplify the stored charges during a sensing phase that actively amplifies the stored charges; and
use the first power source after the second power source to further amplify the stored charges in actively amplifying the stored charges.

5. The apparatus of claim 4, wherein the sense amplifier is configured to change from the second power source to the first power source according to a timing that corresponds to a difference between the intermediate read voltage and the target read voltage.

6. The apparatus of claim 5, wherein:
the sense amplifier includes a sense node;
amplifying the stored charges corresponds to amplifying a voltage at the sense node using the second and the first power sources; and
the timing for changing from the second power source to the first power source corresponds to an estimated timing of when voltage at the sense node matches or is within a threshold range of the intermediate read voltage.

7. The apparatus of claim 5, wherein the intermediate restoration voltage is at least half of the target read voltage.

8. The apparatus of claim 4, wherein the sense amplifier is configured to implement a threshold voltage compensation (VTC) phase using the intermediate read voltage from the second power source wherein:
the VTC phase occurs before the sensing phase, and
the VTC phase includes providing the intermediate read voltage to one or more internal nodes within the sense amplifier to compensate for threshold voltage of one or more transistors used during the sensing phase and/or in transitioning from the VTC phase to the sensing phase.

9. The apparatus of claim 1, further comprising:
a sensor coupled to the sense amplifier that is configured to provide one or more output readings that measures an operating condition of the apparatus; and
wherein the intermediate read voltage is adjusted prior to amplifying the charges stored in the memory cell when the one or more output readings from the sensor fail to satisfy an operational threshold.

10. A method of operating an apparatus, the method comprising:
operating a sense amplifier to amplify charges stored in a memory cell using an intermediate restoration voltage;
operating the sense amplifier to amplify the stored charges using a target voltage that is greater than the intermediate restoration voltage; and
reading a data value represented by the stored charges using the amplified result thereof.

11. The method of claim 10, wherein:
a connection relay is disposed between the memory cell and the apparatus and configured to selectively couple the apparatus to the memory cell for reading the data value from the memory cell;
the target read voltage corresponds to a restoration voltage level used in amplifying the stored charges to one or more targeted levels in reading the data value; and
the method further comprising:
performing, using the intermediate read voltage, a threshold voltage compensation (VTC) before the connection relay is activated to connect the apparatus to the memory cell, wherein performing the VTC includes preparing the sense amplifier to actively amplify the stored charges.

12. The method of claim 11, wherein the target read voltage is equivalent to a voltage used to write data into the memory cell.

13. The method of claim 10, further comprising:
operating a connection relay to communicatively couple the sense amplifier to the memory cell for reading the data value from the memory cell; and
wherein:
operating the sense amplifier to amplify the stored charges using the intermediate restoration voltage includes amplifying the stored charges to an initial magnitude; and
operating the sense amplifier to amplify the stored charges using the target voltage includes amplifying the stored charges from the initial magnitude to a final magnitude used for reading the data value.

14. The method of claim 13, further comprising:
providing the intermediate restoration voltage from a first power source in preparation for operating the sense amplifier using the intermediate restoration voltage;
providing the target voltage from a second power source according to a timing that corresponds to a difference between the intermediate read voltage and the target read voltage.

15. The method of claim 14, wherein:
the apparatus includes a sense node connected to the connection relay, wherein amplifying the stored charges corresponds to amplifying a voltage at the sense node using the first and second power sources; and
the timing for changing from the second power source to the first power source corresponds to an estimated timing of when voltage at the sense node matches or is within a threshold range of the intermediate read voltage.

16. A memory device, comprising:
memory cells each configured to store charges representative of one or more data values;
a first digit line DL coupled to a first set of the memory cells;
a second digit line DLb coupled to a second set of the memory cells;
a sense amplifier coupled to the first digit line DL and the second digit line DLb, the sense amplifier configured to amplify voltages on the first digit line DL and/or the second digit line DLb for reading the one or more data values stored in the memory cells,
wherein the voltages correspond to the charges stored in the memory cells,
wherein the sense amplifier is configured to amplify the voltages using an intermediate restoration voltage supplied and then a target voltage, wherein the target read voltage is greater than the intermediate read voltage.

17. The memory device of claim 16, wherein the sense amplifier is configured to change from the intermediate restoration voltage to the target voltage according to a timing that corresponds to a difference between the intermediate restoration voltage and the target voltage.

18. The memory device of claim 17, wherein:
the sense amplifier includes a sense node connected to the first digit line DL and/or the second digit line DLb;
amplifying the voltages on the first digit line DL and/or the second digit line DLb includes amplifying the voltage at the sense node using the intermediate and target voltages; and
the timing for changing from the intermediate restoration voltage to the target voltage corresponds to an estimated timing of when the voltage at the sense node matches or is within a threshold range of the intermediate read voltage.

19. The memory device of claim 16, wherein:
using the intermediate restoration voltage and then the target voltage to amplify the stored charges that correspond to a sensing phase; and
the sense amplifier is configured to implement a threshold voltage compensation (VTC) phase using the intermediate read voltage,
wherein the VTC phase occurs before the sensing phase, and
wherein the VTC phase includes providing the intermediate read voltage to one or more internal nodes within the sense amplifier to compensate for threshold voltage of one or more transistors used during the sensing phase and/or in transitioning from the VTC phase to the sensing phase.

20. The memory device of claim 16, further comprising:
a sensor coupled to the sense amplifier that is configured to provide one or more output readings that measures operating condition of the memory device; and
wherein the sense amplifier is configured to adjust the intermediate read voltage prior to amplifying the voltages on the first digit line DL and/or the second digit line DLb when the one or more output readings from the sensor fail to satisfy an operational threshold.
